(19) United States
(12) Patent Application Publication
(10) Pub. No.: US 2026/0100874 A1
(43) Pub. Date: Apr. 9, 2026

(54) TECHNIQUES FOR REDUCING PEAK-TO-AVERAGE POWER RATIO VIA RATELESS CODES

(71) Applicant: QUALCOMM Incorporated, San Diego, CA (US)

(72) Inventors: Liangming WU, Beijing (CN); Hao XU, Beijing (CN); Jian LI, Shanghai (CN); Changlong XU, Beijing (CN); Jing JIANG, San Diego, CA (US)

(21) Appl. No.: 19/112,746

(22) PCT Filed: Nov. 1, 2023
(86) PCT No.: PCT/CN2023/128974

§ 371 Date: Mar. 18, 2025

(30) Foreign Application Priority Data
Nov. 30, 2022 (WO) PCTCN2022135291

(51) Int. Cl. H04L 27/26

(52) U.S. Cl. CPC H04L 27/2615; H04L 27/2623

(57) ABSTRACT

The present invention discloses techniques and apparatuses for reducing a peak-to-average power ratio (PAPR) via rateless codes. In some aspects, a transmitter may generate, from a set of source packets, a set of rateless code packets that each correspond to a different combination of one or more of the set of source packets. The transmitter may select, from each subset of consecutive packets in the set of rateless code packets, one or more packets with a lowest PAPR among respective PAPRs associated with each packet included in the respective subset of consecutive packets. The transmitter may transmit a set of output packets that includes the one or more packets selected from each subset of consecutive packets in the set of rateless code packets. Numerous other aspects are described.

### CROSS-REFERENCE TO RELATED APPLICATION

This patent application claims priority to Patent Cooperation Treaty (PCT) Application No. PCT/CN2022/135291, filed on Nov. 30, 2022, entitled “TECHNIQUES FOR REDUCING PEAK-TO-AVERAGE POWER RATIO VIA RATELESS CODES,” and assigned to the assignee hereof. The disclosure of the prior application is considered part of and is incorporated by reference in this patent application.

### FIELD OF THE DISCLOSURE

Aspects of the present disclosure generally relate to wireless communication and to techniques and apparatuses for reducing a peak-to-average power ratio (PAPR) via rateless codes.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a transmitter. The method may include generating, from a set of source packets, a set of rateless code packets that each correspond to a different combination of one or more of the set of source packets. The method may include selecting, from each subset of consecutive packets in the set of rateless code packets, one or more packets with a lowest peak-to-average power ratio (PAPR) among respective PAPRs associated with each packet included in the respective subset of consecutive packets. The method may include transmitting a set of output packets that includes the one or more packets selected from each subset of consecutive packets in the set of rateless code packets.

Some aspects described herein relate to a transmitter for wireless communication. The transmitter may include a memory and one or more processors coupled to the memory. The one or more processors may be configured to generate, from a set of source packets, a set of rateless code packets that each correspond to a different combination of one or more of the set of source packets. The one or more processors may be configured to select, from each subset of consecutive packets in the set of rateless code packets, one or more packets with a lowest PAPR among respective PAPRs associated with each packet included in the subset of consecutive packets. The one or more processors may be configured to transmit a set of output packets that includes the one or more packets selected from each subset of consecutive packets in the set of rateless code packets.

Some aspects described herein relate to a non-transitory computer-readable medium that stores a set of instructions for wireless communication by a transmitter. The set of instructions, when executed by one or more processors of the transmitter, may cause the transmitter to generate, from a set of source packets, a set of rateless code packets that each correspond to a different combination of one or more of the set of source packets. The set of instructions, when executed by one or more processors of the transmitter, may cause the transmitter to select, from each subset of consecutive packets in the set of rateless code packets, one or more packets with a lowest PAPR among respective PAPRs associated with each packet included in the subset of consecutive packets. The set of instructions, when executed by one or more processors of the transmitter, may cause the transmitter to transmit a set of output packets that includes the one or more packets selected from each subset of consecutive packets in the set of rateless code packets.

Some aspects described herein relate to an apparatus for wireless communication. The apparatus may include means for generating, from a set of source packets, a set of rateless code packets that each correspond to a different combination of one or more of the set of source packets. The apparatus may include means for selecting, from each subset of consecutive packets in the set of rateless code packets, one or more packets with a lowest PAPR among respective PAPRs associated with each packet included in the subset of consecutive packets. The apparatus may include means for transmitting a set of output packets that includes the one or more packets selected from each subset of consecutive packets in the set of rateless code packets.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4-5 are diagrams illustrating examples of network coding, in accordance with the present disclosure.

FIG. 6 is a diagram illustrating an example of rateless code generation, in accordance with the present disclosure.

FIGS. 7A-7D are diagrams illustrating examples associated with reducing a peak-to-average power ratio (PAPR) via rateless codes, in accordance with the present disclosure.

FIG. 8 is a diagram illustrating an example process associated with reducing a PAPR via rateless codes, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

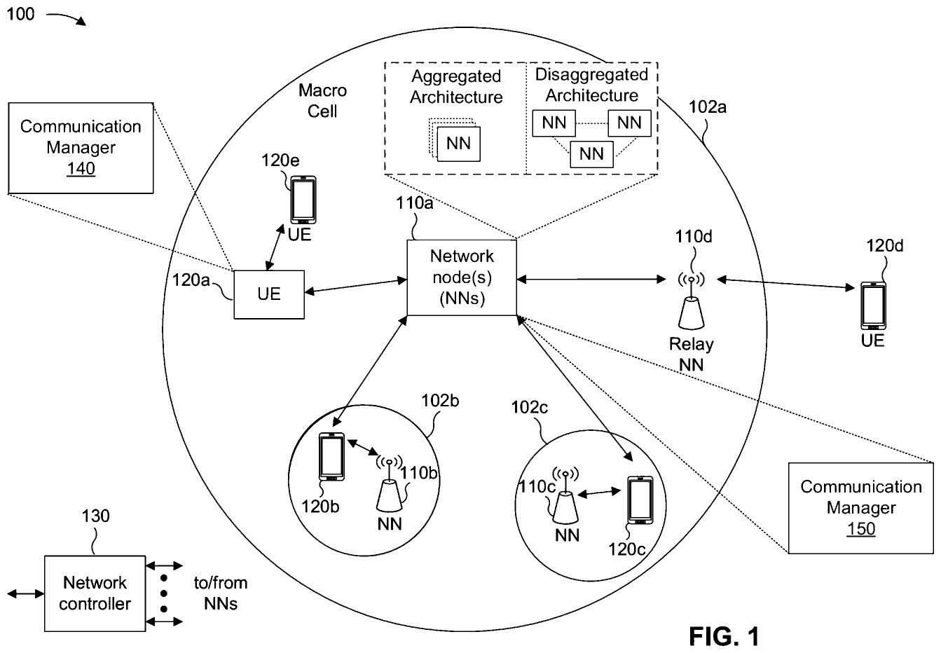

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120c) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a UE 120 may include a communication manager 140 and a network node 110 may include a communication manager 150. As described in more detail elsewhere herein, the communication manager 140 and/or the communication manager 150 may generate, from a set of source packets, a set of rateless code packets that each correspond to a different combination of one or more of the set of source packets; select, from each subset of consecutive packets in the set of rateless code packets, one or more packets with a lowest peak-to-average power ratio (PAPR) among respective PAPRs associated with each packet included in the subset of consecutive packets; and transmit a set of output packets that includes the one or more packets selected from each subset of consecutive packets in the set of rateless code packets. Additionally, or alternatively, the communication manager 140 and/or 150 may perform one or more other operations described herein.

As indicated above, FIG. 1 is provided as an example. Other examples may differ from what is described with regard to FIG. 1.

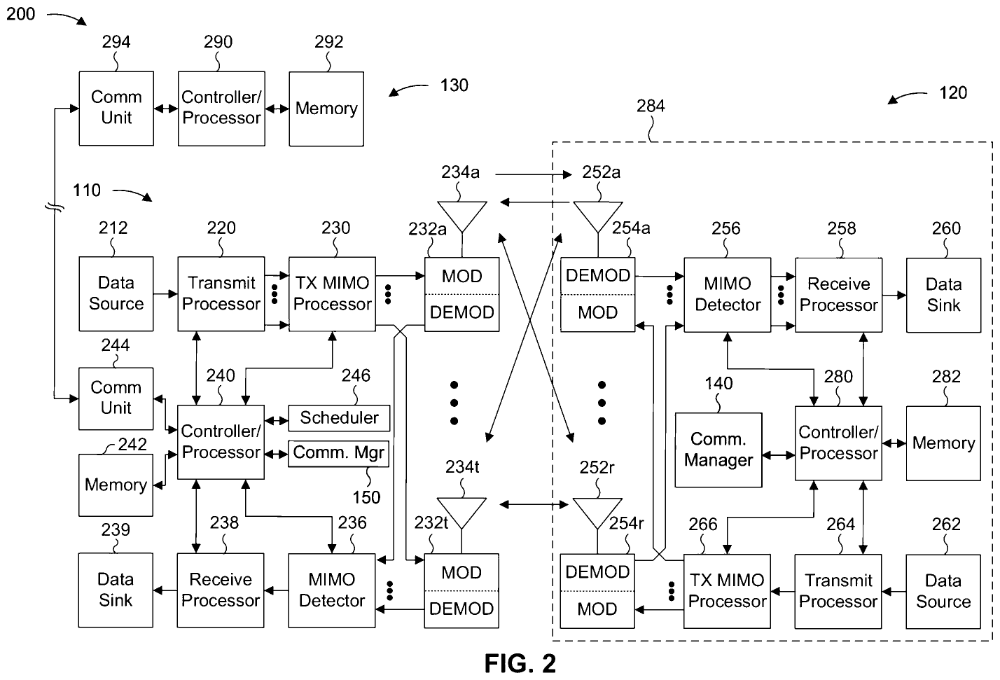

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

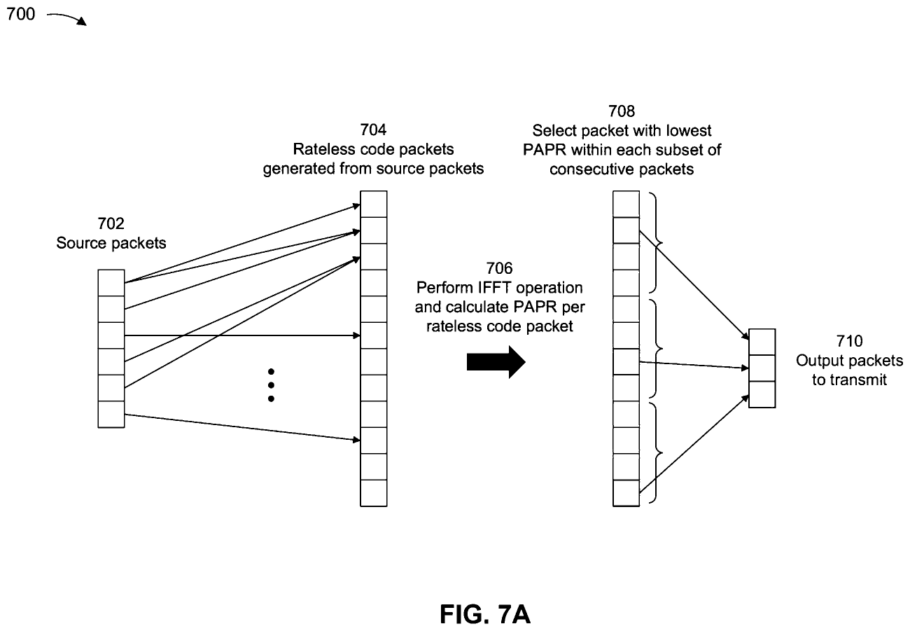

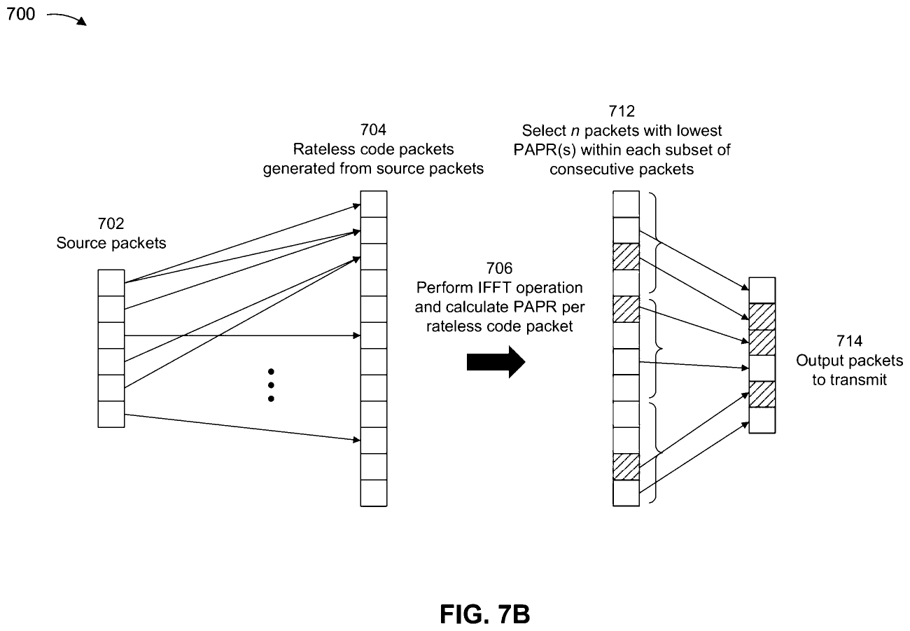

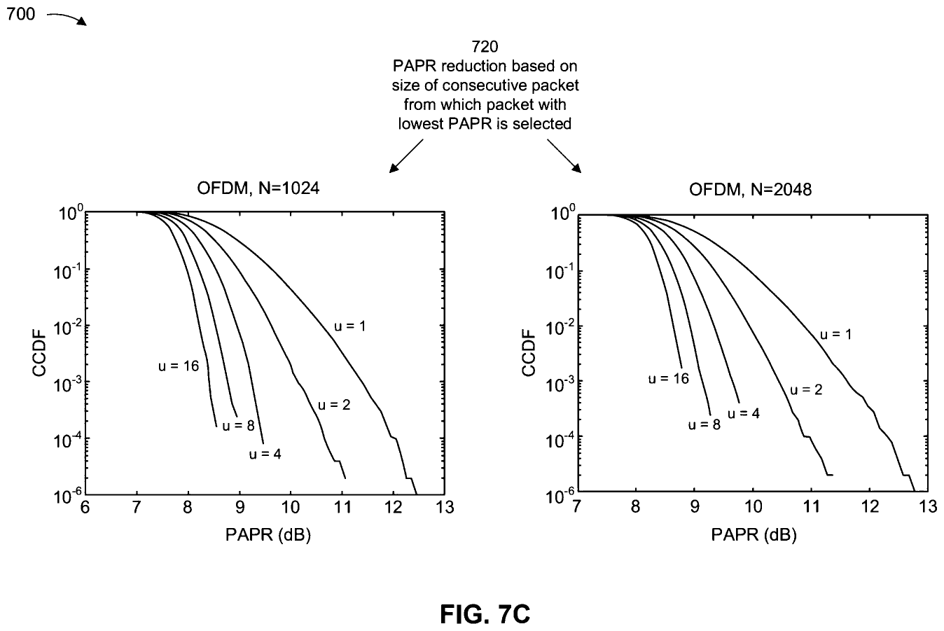

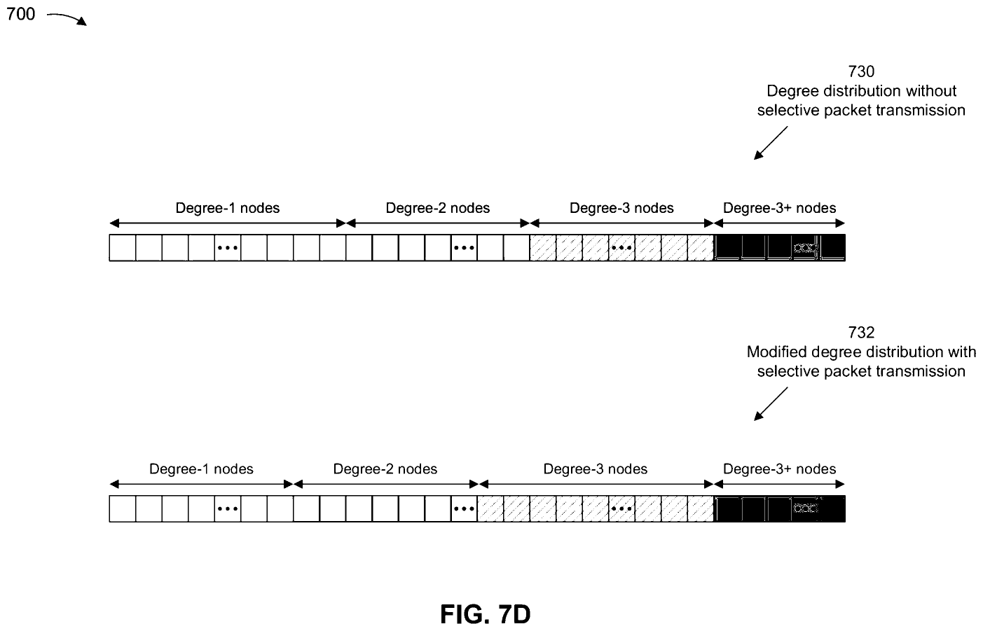

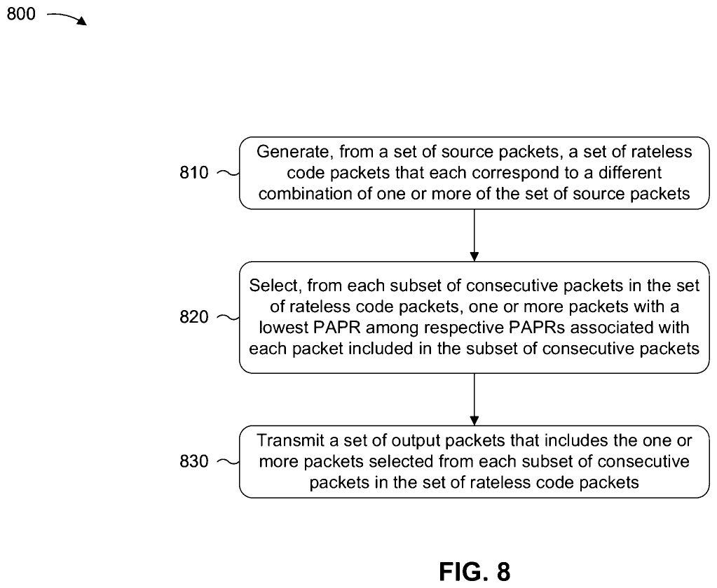

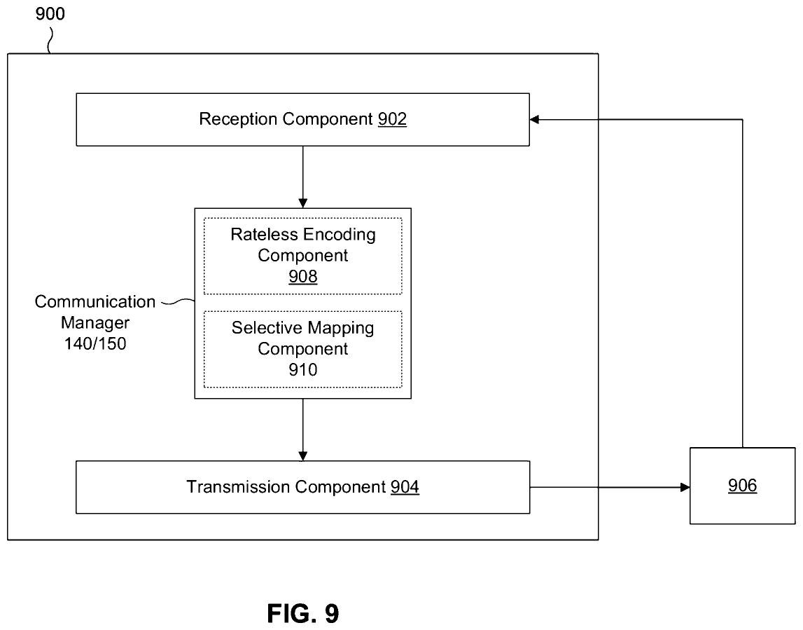

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 7A-7D, FIG. 8, and/or FIG. 9).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 7A-7D, FIG. 8, and/or FIG. 9).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

The controller/processor 240 of the network node 110, the controller/processor 280 of the UE 120, or any other component(s) of FIG. 2 may perform one or more techniques associated with reducing a PAPR via rateless codes, as described in more detail elsewhere herein. In some aspects, the transmitter described herein is the UE 120 and/or the network node 110, is included in the UE 120 and/or the network node 110, or includes one or more components of the UE 120 and/or the network node 110 shown in FIG. 2. For example, the controller/processor 240 of the network node 110, the controller/processor 280 of the UE 120, or any other component(s) (or combinations of components) of FIG. 2 may perform or direct operations of, for example, process 800 of FIG. 8 and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 800 of FIG. 8 and/or other processes as described herein. In some examples, executing instructions may include running the instructions, converting the instructions, compiling the instructions, and/or interpreting the instructions, among other examples.

In some aspects, a transmitter includes means for generating, from a set of source packets, a set of rateless code packets that each correspond to a different combination of one or more of the set of source packets; means for selecting, from each subset of consecutive packets in the set of rateless code packets, one or more packets with a lowest PAPR among respective PAPRs associated with each packet included in the subset of consecutive packets; and/or means for transmitting a set of output packets that includes the one or more packets selected from each subset of consecutive packets in the set of rateless code packets. In some aspects, the means for the transmitter to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. Additionally, or alternatively, the means for the transmitter to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

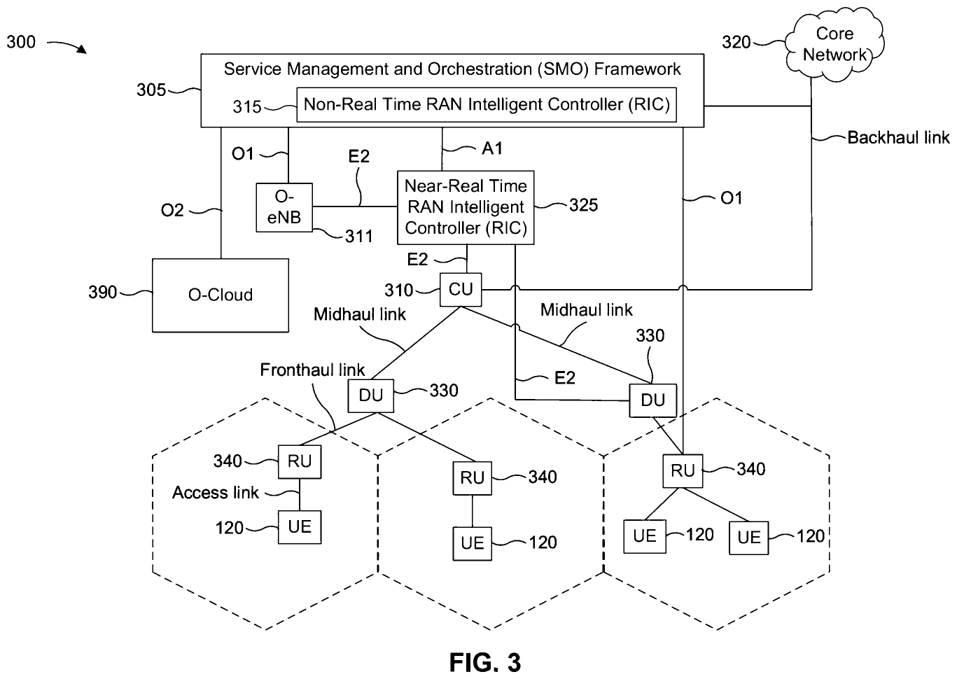

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

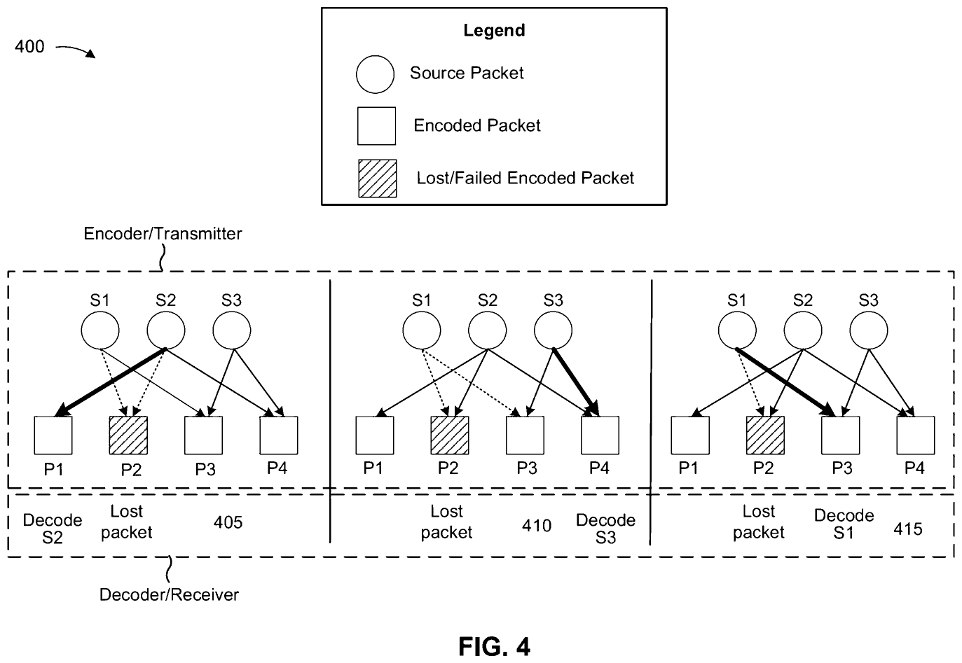

FIG. 4 is a diagram illustrating an example 400 of network coding, in accordance with the present disclosure. Network coding may also be referred to as erasure coding and recovery. As shown in FIG. 4, an encoder (or transmitter) may communicate with a decoder (or receiver). The encoder is sometimes also referred to as a transmitter, an encoder node, or a transmitter node. The encoder may include a UE 120, a network node 110, and/or an IAB device, among other examples. The decoder is sometimes also referred to as a receiver, a decoder node, or a receiver node. The decoder may include a UE 120, a network node 110, and/or an IAB device, among other examples.

As shown in FIG. 4, an encoder (or transmitter) may encode data, shown as a set of source packets or original packets (S1, S2, and S3), into a set of encoded packets using network coding. While FIG. 4 uses “packets” as example data, it will be appreciated that the data may include any type of communication (e.g., transport blocks), and is not limited to packets. An encoded packet may be the same as a source packet, may be a redundancy version of a source packet, may include a combination of multiple source packets (e.g., a subset of the source packets), and/or may include a redundancy version of the combination of multiple source packets. The number of encoded packets may be the same as or different than the number of source packets. In some aspects, the number of encoded packets may be unlimited (e.g., the encoder may generate any number of encoded packets), such as when using a rateless network coding scheme. In example 400, the encoder encodes K source packets (where K=4) into N encoded packets (where N=4). The encoder transmits the encoded packets to a decoder (or receiver). The decoder uses network coding to decode the encoded packets and recover the source packets. As used herein, network coding may be performed using any type of network coding scheme, such as fountain coding, linear network coding, random linear network coding, Luby transform (LT) network coding, and/or Raptor network coding, among other examples.

In example 400, the encoder encodes three source packets (S1, S2, and S3) into four encoded packets: P1 (e.g., that carries S2), P2 (e.g., that carries S1+S2), P3 (e.g., that carries S1+S3), and P4 (e.g., that carries S2+S3). The encoder may transmit the four encoded packets to the decoder. In this example, the packet P2 (carrying S1+S2) is not successfully received by the decoder. In a first operation 405, the decoder decodes the packet P1 (carrying S2). In a second operation 410, the decoder obtains S3 from the packet P4 (carrying S2+S3) because the decoder has already decoded S2 and can use combining to obtain S3 from S2+S3. In a third operation 415, the decoder obtains S1 from the packet P3 (carrying S1+S3) because the decoder has already decoded S3 and can use combining to obtain S1 from S1+S3. In some aspects, an encoded packet may include an indication (e.g., in a header of the encoded packet) that indicates the source packet(s) that are included in the encoded packet. Thus, the decoder can obtain S1, S2, and S3 despite P2 failing, and using less overhead than PDCP duplication. For example, PDCP duplication may duplicate all of the source packets for a total of six transmissions, while the example network coding shown in FIG. 4 uses only four transmissions.

In some cases, the encoder may continue to transmit encoded packets (e.g., the same combination of encoded packets or different combinations of encoded packets) to the decoder until the encoder receives a notification from the decoder. For example, the decoder may successfully receive the source packets or may abort decoding, which may trigger the decoder to send a notification to the encoder. The notification may include, for example, an acknowledgement (ACK) and/or a stop message. In some cases, the decoder may transmit an ACK for each original packet that is successfully received. Additionally, or alternatively, the decoder may transmit an ACK upon successful reception of all of the source packets. Upon receiving the notification, the encoder may encode additional data (e.g., a new set of source packets, such as S4, S5, and S6), and may transmit encoded packets to the decoder, in a similar manner as described above, until all of the data has been transmitted and/or successfully received. Alternatively, to conserve network resources and reduce overhead, the encoder may not transmit an ACK or a negative acknowledgement (NACK) for received packets.

In some cases, such as when using a Raptor network coding scheme, the encoder may perform inner coding, or precoding, to generate a set of intermediate packets, that include a set of redundant packets, from the source packets. A redundant packet may be a copy of a source packet or a redundancy version of a source packet. In some aspects, a redundant packet may be a low density parity check (LDPC) packet. For example, the encoder may apply inner coding to generate K′ intermediate packets (e.g., original plus redundant packets from K source packets). The encoder may then perform outer coding (e.g., fountain coding and/or LT network coding) to generate N encoded packets from the K′ intermediate packets, in a similar manner as described above. As a result, the encoding and/or decoding complexity of the Raptor network coding scheme may be linear. The encoded packets may include a set of systemic packets and a set of repair packets. In some aspects, the decoder may choose to not decode a packet included in the set of systematic symbols that has a high decoding complexity (e.g., is associated with a high encoding degree and/or is associated with a high quantity of source packets). The decoder may recover the source packets associated with the packet that is not decoded from one or more packets included in the set of repair packets. The one or more packets included in the set of repair packets may be associated with a lower decoding complexity. As a result, the decoding complexity may be reduced.

In some examples, the network coding may be viewed as a linear system (e.g., over a Galois field) with three variables and four linearly independent constraints. For example, the three variables may correspond to the source packets (e.g., S1, S2, and S3) and the four linearly independent constraints may correspond to the four encoded packets. Using the linear system, any of the three variables that have been subject to an erasure (e.g., transmission error) may be recovered based at least in part on a portion of the three original packets and based at least in part on a portion of the four encoded packets. Network coding (e.g., erasure coding and recovery) may enable a receiver to recover a communication that has been erased (e.g., lost or corrupted) during transmission. The recovery of the erased communication, without requiring retransmission by the transmitter, may reduce the overall number of retransmissions by the transmitter and/or the overall load on the network.

As indicated above, FIG. 4 is provided as an example. Other examples may differ from what is described with regard to FIG. 4.

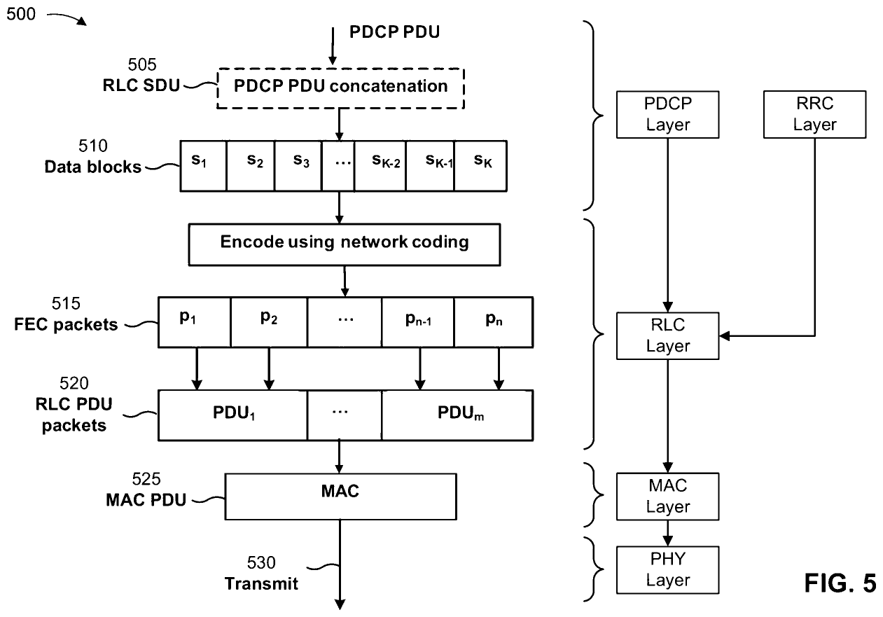

FIG. 5 is a diagram illustrating an example 500 of network coding, in accordance with the present disclosure. The operations described in connection with FIG. 5 may be performed by a transmitter (also referred to as an encoder), such as a UE 120 or a network node 110.

As shown by reference number 505, a transmitter may generate an RLC service data unit (SDU) from one or more PDCP protocol data units (PDUs). In some aspects, a single PDCP PDU is included in an RLC SDU. In some aspects, multiple PDCP PDUs are included in an RLC SDU (e.g., by concatenating multiple PDCP PDUs). In some aspects, the transmitter determines whether to include a single PDCP PDU in a single RLC SDU or whether to concatenate multiple PDCP PDUs in a single RLC SDU based at least in part on a size of the PDCP PDU. For example, if the size of the PDCP PDU satisfies (e.g., is greater than or equal to) a threshold, then the transmitter may include only the PDCP PDU (e.g., a single PDCP PDU) in a single RLC SDU. If the size of the PDCP PDU does not satisfy (e.g., is less than or equal to) the threshold, then the transmitter may concatenate multiple PDCP PDUs (e.g., a set of PDCP PDUs with a total size that is less than or equal to the threshold) into a single RLC SDU.

As shown by reference number 510, the transmitter may divide the RLC SDU into a plurality of data blocks. For example, the transmitter may divide the RLC SDU into K data blocks, shown as s₁ through s_{K}, based at least in part on the set of network coding parameters. In some aspects, the set of network coding parameters specify the value of K for a particular set of sub-parameters, such as a payload size for the RLC SDU and/or a size of a sequence number field in an RLC PDU header for the RLC SDU. In some aspects, the transmitter determines the value of K for a set of sub-parameters.

In some aspects, the operations associated with reference number 505 and 510 may be performed at the PDCP layer of the transmitter. The PDCP layer may provide the data blocks to the RLC layer of the transmitter. As shown by reference number 515, the transmitter may encode the K data blocks into N FEC packets using network coding. For example, the transmitter may encode the K data blocks into the N FEC packets, shown as p₁ through pₙ, based at least in part on a rateless code, such as a network code, a fountain code, an LT code, and/or a Raptor code, among other examples. In particular, the transmitter may encode the K data blocks into the N FEC packets such that the N FEC packets include additional information or bits for purposes of FEC. This permits FEC packets to be recovered by a receiver, for example, if the quantity of received FEC packets is larger than the quantity of K data blocks regardless of which FEC packets are received.

In some aspects, the number of RLC packets (e.g., the value of N) is based at least in part on the set of network coding parameters. In some aspects, the set of network coding parameters specifies the value of N for a particular set of sub-parameters, a delay budget for the RLC SDU, available encoding and decoding computation resources of the transmitter, the value of K (e.g., the quantity of data blocks), a target error probability for one or more RLC PDU packets for the N FEC packets, channel conditions for transmission of the RLC PDU packets(s), and/or the type of network code that is to be used to encode the K data blocks into the N FEC packets, among other examples. In some aspects, the transmitter may determine the value of N for a set of sub-parameters.

As shown by reference number 520, the transmitter may map the N FEC packets to a corresponding M RLC PDU packets. For example, the transmitter may map N FEC packets to M RLC PDU packets, shown as PDU₁ through PDUₘ, such that each RLC PDU includes a plurality of FEC packets (e.g., two FEC packets per RLC PDU packet, four FEC packets per RLC PDU packet, or another quantity of FEC packets per RLC PDU packet). In some aspects, the operations associated with reference number 515 and 520 are performed at the RLC layer of the transmitter. The RLC layer may receive an indication of the set of network coding parameters from the RRC layer and may perform the operations associated with reference number 515 and 520 based at least in part on the set of network coding parameters.

The RLC layer may provide the M RLC PDU packets to the MAC layer of the transmitter. As shown by reference number 525, the transmitter may generate a MAC PDU for the M RLC PDU packets. In some aspects, the MAC PDU includes an RLC PDU header or a MAC PDU header, which may include information associated with each of the M RLC PDUs. For example, the RLC PDU header or MAC PDU header may include a sequence number field, which may indicate a sequence number associated with each of the M RLC PDUs. In some aspects, the operations associated with reference number 525 are performed at the MAC layer of the transmitter.

The MAC layer of the transmitter may provide the MAC PDU to the PHY layer of the transmitter. As shown by reference number 530, the transmitter may transmit the M RLC PDU packets (e.g., in the MAC PDU) to a receiver (also referred to as a decoder), such as a UE 120 or a network node 110. In some aspects, the PHY layer of the transmitter may transmit the M RLC PDU packets (e.g., in the MAC PDU) over a wireless physical channel, such as a physical downlink shared channel (PDSCH), a physical downlink control channel (PDCCH), a physical uplink shared channel (PUSCH), a physical uplink control channel (PUCCH), a physical sidelink control channel (PSCCH), and/or a physical sidelink shared channel (PSSCH).

As indicated above, FIG. 5 is provided as an example. Other examples may differ from what is described with regard to FIG. 5.

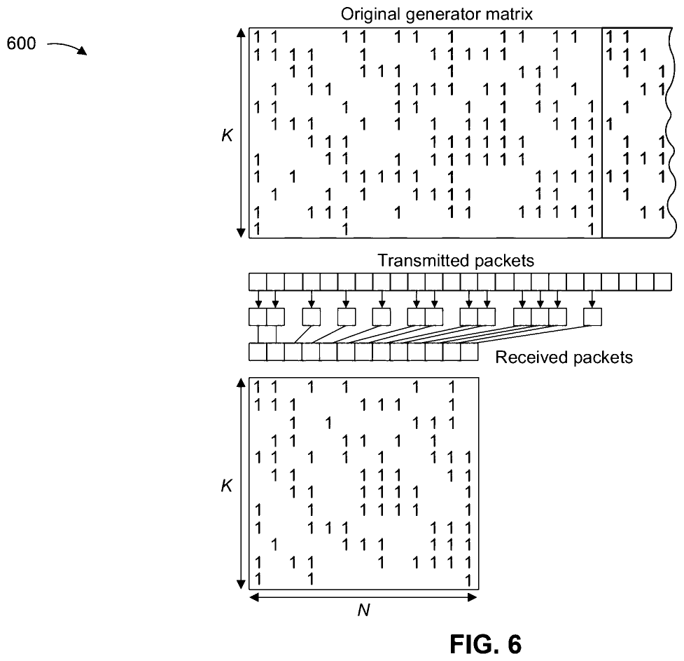

FIG. 6 is a diagram illustrating an example 600 of rateless code generation, in accordance with the present disclosure. Rateless codes use a potentially limitless sequence of encoding symbols. Accordingly, transmitted packets may be recovered from any subset of the encoding symbols as long as the size of the subset is equal to or only slightly larger than the number of source symbols. Therefore, rateless codes have relatively low reception overhead (e.g., less than 2%) with relatively high probability (e.g., up to and including 99.9999%). Some examples of rateless codes include fountain codes, such as an LT code, and/or a Raptor code, among other examples.

As shown in FIG. 6, rateless codes use a generator matrix G with K rows and an unlimited number of columns. For example, K may depend on a size of the content to be encoded. The generator matrix G may be used to generate packets for transmission. For example, the packets for transmission may be encoded according to:

$${η}^{‵} {}^{‶} 0$$

where \acute{η} is packet j for transmission, [symbol] is a portion of the content to be encoded (e.g., a source packet), and ″0 is a corresponding element of the generator matrix G. This equation is provided as an example. Other examples may differ from the equation described above.

As shown in FIG. 6, only a subset of the transmitted packets is needed to recover the content. For example, the recovered packets may be decoded according to:

$${}^{‵} Ω {η}^{‵} {}^{‶} 0$$

where ′Ω is a portion of the content to be recovered, \acute{η} is packet n that was received, and ″0 is a corresponding element of the inverse of the generator matrix G. Accordingly, as long as sufficient packets are received to estimate the generator matrix G to order K, and as long as the estimated matrix is invertible, the content may be recovered. This equation is provided as an example. Other examples may differ from the equation described above.

As indicated above, FIG. 6 is provided as an example. Other examples may differ from what is described with regard to FIG. 6.

FIGS. 7A-7D are diagrams illustrating examples 700 associated with reducing a PAPR via rateless codes, in accordance with the present disclosure. The operations described in connection with FIGS. 7A-7D may be performed by a transmitter (also referred to as an encoder), such as a UE 120 or a network node 110, to reduce a PAPR associated with one or more OFDM signals that are transmitted over a wireless channel.

In particular, OFDM is a multi-carrier modulation technique that divides an available bandwidth into a number of orthogonal subcarriers that are transmitted with equal intervals. OFDM is generally considered an efficient multi-carrier modulation technique that offers advantages such as resilience to RF interference, low multi-path distortion, and increased spectral efficiency (e.g., due to case of integration with MIMO). However, transmitted OFDM signals (or OFDM waveforms), where an output is a superposition of multiple subcarriers via an inverse fast Fourier transform (IFFT) operation, can sometimes have a high PAPR. For example, a transmitted OFDM signal is usually not associated with a constant analog transmit power. Rather, the instantaneous output of an OFDM signal may have large peaks, whereby the PAPR of a baseband OFDM signal that is continuous in time may be defined as a ratio between a maximum instantaneous power and an average power of the OFDM signal in a time period. In some cases, the peaks in the OFDM signal can produce deleterious effects such as spectral spreading and/or changes in a constellation signal such as cloud-like shaping, attenuation, rotation, and/or warping. In general, in cases where the transmitter has a high PAPR, the average power can be significantly reduced relative to a constant saturation power. For example, the transmitter may need to operate a power amplifier in a linear regime to avoid signal distortion, where the PAPR of a transmitted signal generally determines a power backoff that can impact efficiency of the power amplifier.

Accordingly, some aspects described herein relate to a PAPR reduction technique that may be implemented via rateless coding techniques. For example, some aspects described herein relate to techniques that may use selective mapping, sometimes abbreviated SLM, to reduce a PAPR associated with a transmitted signal. For example, selective mapping techniques may use u hypotheses to mask an original bit sequence to be transmitted, where the u hypotheses may each result in a candidate bit sequence associated with a PAPR value. Accordingly, the transmitter may select the mask associated with one or more of the u hypotheses that results in a candidate bit sequence with a lowest PAPR value, and the candidate bit sequence with the lowest PAPR value may be selected for transmission. In this example, a larger value for u may generally result in a greater performance improvement (e.g., because the larger number of hypotheses may generate more candidate bit sequences with a lower PAPR value). However, one challenge that may arise when using selective mapping techniques to reduce a PAPR of a transmitted signal is that signaling is needed to indicate which of the u hypotheses was used to mask the original bit sequence. For example, in cases where the transmitted bit sequence is generated with a particular mask sequence (e.g., a Gold sequence) with a specific random start number, the random start number may be explicitly signaled. Additionally, or alternatively, the hypothesis used to mask the original bit sequence may be implicitly signaled, in which case the signaling overhead is carried by sacrificing one or more information bits (e.g., jointly with a channel code) to indicate the hypothesis used to mask the original bit sequence. For example, a payload with log: (u) bits may be needed to generate u sequences (e.g., two bits are needed to carry an indication of which of four sequences was used to mask an original bit sequence in a transmitted signal).

Accordingly, some aspects described herein may be used to reduce a PAPR associated with a transmitted signal via rateless codes (e.g., based on the selective mapping techniques described above). For example, as described herein, a rateless coding technique may generally receive a set of source packets to be transmitted (e.g., a set of k source packets) and use a linear combination technique based on an exclusive or (XOR) relationship to generate a set of rateless code packets. For example, in a case where there are ten (10) source packets (or source symbols), a rateless encoder may generate a set of rateless code packets in which a first rateless code packet corresponds to a first source packet, a second rateless code packet corresponds to the first source packet XORed with a second source packet, a third rateless code packet corresponds to the first source packet XORed with a third source packet, a fourth rateless code packet corresponds to the first source packet XORed with a fifth source packet, and so on.

In other words, given a set of k source packets, a rateless encoder may generate a set of rateless code packets that includes up to 2^{k} packets, which may correspond to any suitable linear combination of the source packets. In this case, if k is sufficiently large, the rateless codes can be used to construct transmit packets with an infinite transmission redundancy (e.g., for practical purposes, because the number of combinations, 2^{k}, will be correspondingly large). In some aspects, the transmitter may then generate a set of output packets to be transmitted, where the output packets may be selected to have a low PAPR. For example, the set of rateless code packets may be divided or otherwise partitioned into different subsets, and the transmitter may select, in each subset, a configured number of packets associated with a lowest PAPR. For example, in some aspects, the transmitter may select one packet associated with a lowest PAPR in each subset, or the transmitter may select multiple packets associated with lowest PAPRs in each subset. Accordingly, the transmitter may selectively transmit only the rateless code packets with the lowest PAPR values to reduce the PAPR associated with the transmitted signal(s). Furthermore, because the rateless code packets are each associated with a rateless code symbol index that defines the XOR relationship with one or more source packets, some aspects described herein may address issues related to the need to otherwise signal which sequence is used in a transmitted signal in a selective mapping.

For example, as shown in FIG. 7A, reference number 702 depicts a set of source packets to be transmitted by the transmitter, where the set of source packets includes k source packets. As shown by reference number 704, in a first operation, the transmitter may generate a set of rateless code packets from the set of k source packets, where each rateless code packet corresponds to a different linear combination of one or more packets included in the set of source packets. For example, in some aspects, the set of rateless code packets may be generated using a generator matrix in a similar manner as described above with reference to FIG. 6. For example, given a set of k source packets, the generator matrix may include k rows and an unlimited number of columns that are indexed with ones (1s) to indicate which of the k source packets are selected and XORed in the set of rateless code packets, which generally includes more combinations than the set of source packets. As shown by reference number 706, in a second operation, the transmitter may perform an IFFT operation and a PAPR calculation for each rateless code packet. Accordingly, as shown by reference number 708, in a third operation, the transmitter may divide the set of rateless code packet into multiple subsets that each include u consecutive packets, and the transmitter may select, from each subset of u consecutive packets, one or more packets with a lowest PAPR.

For example, as shown in FIG. 7A, u may have a value of four (4), whereby the transmitter may select one packet out of every four candidates that has a lowest PAPR and include the selected packet in a set of output packets to be transmitted. Additionally, or alternatively, the PAPR-based selection may be configured to select multiple packets from a subset of candidate packets, such as selecting three packets that have a lowest PAPR value out of every twelve consecutive candidate packets. As shown by reference number 710, the transmitter may then transmit a set of output packets to a receiver via a wireless channel, where the set of output packets includes a down-selected subset of the rateless code packets associated with low PAPR values (e.g., the set of output packets includes, for each subset of consecutive packets within the set of rateless code packets, one or more packets with a lowest PAPR value). Additionally, or alternatively, as shown by reference number 712 in FIG. 7B, the PAPR-based selection may be configured to select multiple packets from each subset of candidate packets. For example, FIG. 7B depicts a use case where u has a value of four (4), and the transmitter selects two packets out of every four candidates that have lowest PAPRs. Accordingly, the transmitter may generally select, out of every group of u candidates, n packets that have lowest PAPR values, where n is an integer having a value in a range from 1 to u−1. As shown by reference number 714 in FIG. 7B, the transmitter may then generate a set of output packets to transmit, where the set of output packets includes the n packets selected from every group of u candidates.

Accordingly, referring to FIG. 7C, reference number 720 depicts example PAPR reductions that may be achieved using the rateless coding techniques described herein. For example, FIG. 7C illustrates a first plot and a second plot, each of which includes PAPR values on an x-axis and a complementary cumulative distribution function (CCDF) on a y-axis, where the first plot and the second plot indicate the PAPR reduction that may be achieved with different values for u (e.g., using different values for the size of the subset of consecutive packets from which the transmitter selects the one or more packets associated with the lowest PAPR value(s)). For example, the first (left-most) plot indicates the PAPR reduction that may be achieved for different values of u when a number of transmit subcarriers, N, has a value of 1024 (meaning that the transmitter performs 1024 IFFT operations). In the illustrated example, u values of 1, 2, 4, 8, and 16 are used, where the PAPR reduction may generally increase as the value of u increases. Furthermore, a similar PAPR reduction is shown in the second (right-most) plot where the number of transmit subcarriers, N, is 2048, and the PAPR reduction increases as the value of u increases.

In some aspects, as described herein, a rateless code symbol index may generally be used to determine an XOR relationship between an original (source) packet and a rateless code packet. For example, in a case where the set of source packets includes k source packets and the set of output packets that are transmitted to the receiver includes n output packets (e.g., where the set of rateless code packets are divided into n groups that each include u consecutive packets and one packet with a lowest PAPR is selected from each of the n groups), the rateless code symbol index may indicate which column in a generator matrix corresponds to an output packet. In this context, a rateless code recovery condition may need to be satisfied to ensure that the receiver can suitably recover the rateless code. For example, if the set of source packets includes k source packets and the rateless code symbol index includes n bits, then the rateless code packet can be recovered by the receiver if the number of consecutive packets in each group, u, satisfies the following rateless code recovery condition:

$$\frac{2}{ó} {}^{7} Ω 1 , ,$$

where ,, is a small fraction. For example, if the number of received packets includes n bits, then there are 2ⁿ possible combinations, which defines an upper bound on the number of transmitted packets. Furthermore, because selective mapping is performed to select the rateless code packets with the lowest PAPR, the actual number of hypotheses associated with the actual transmitted packets will be smaller than the upper bound, which is therefore divided by the value of u. Accordingly, to ensure successful reception, the transmitter may need to guarantee that the number of packets received by the receiver is at least larger than k multiplied by 1 plus ,,, which may place a constraint on the possible value for u. For example, if the set of source packets includes 256 packets (k=256) and the rateless code symbol index has 16 bits (n=16, or two bytes), then the transmitter can support a value of u up to 2⁷, and there is no need to extend the size of the rateless code symbol index because practical deployments generally constrain u to have a value no larger than 32 (or 2⁵). However, if the set of source packets includes 64 packets (k=64) and the rateless code symbol index has 8 bits (n=8, or one byte), then the transmitter can support a value of u up to 2, in which case the number of bits in the rateless code symbol index may need to be increased to support a value of u larger than 2. Furthermore, in general, the value that is selected for u may be a largest value that satisfies the rateless code recovery condition (e.g., up to 2⁵) because the PAPR reduction generally increases as the value of u increases.

In some aspects, as shown in FIG. 7D, the transmitter may configure a modified degree distribution for the set of output packets based on performing the selective mapping (or selective packet transmission) to transmit the set of output packets with the lowest PAPR values. For example, reference number 730 depicts a degree distribution in a typical scenario without selective mapping or selective packet transmission, where the degree distribution includes a relatively higher percentage of degree one nodes to reduce receiver complexity. For example, given k source packets and n output packets, the “degree” of a node generally refers to the number of output packets that are directly connected to or otherwise associated with an input packet (e.g., indicating how many numbers are activated in each column of a received matrix). Typically, the degree distribution is configured such that the (transmitted) output packets include more degree-one nodes, which can reduce receiver-side complexity because the receiver can use simpler techniques such as belief propagation (BP) to calculate or recover the transmitted packets, rather than more complicated algorithms such as Gaussian elimination. However, with selective mapping or selective packet transmission (e.g., where one out of every u packets with a lowest PAPR value is selected for transmission), the degree-one nodes may need to be punctured during transmission, which can complicate receiver processing. Accordingly, as shown by reference number 732, the transmitter may be configured to modify the degree distribution for the set of output packets to increase the percentage of nodes (or transmitted packets) with a degree greater than one in cases where selective mapping or selective packet transmission is performed. For example, the degree distribution may be associated with the value of u, where a larger value for u may be associated with a larger percentage of nodes with a lower degree and the degree distribution includes comparatively more packets with a degree of two or higher to give balance to the decoder complexity and preserve the benefit of the selective mapping techniques.

As indicated above, FIGS. 7A-7D are provided as examples. Other examples may differ from what is described with regard to FIGS. 7A-7D.

FIG. 8 is a diagram illustrating an example process 800 performed, for example, by a transmitter, in accordance with the present disclosure. Example process 800 is an example where the transmitter (e.g., UE 120 and/or network node 110) performs operations associated with reducing a PAPR via rateless codes.

As shown in FIG. 8, in some aspects, process 800 may include generating, from a set of source packets, a set of rateless code packets that each correspond to a different combination of one or more of the set of source packets (block 810). For example, the transmitter (e.g., using communication manager 140 and/or 150 and/or rateless encoding component 908, depicted in FIG. 9) may generate, from a set of source packets, a set of rateless code packets that each correspond to a different combination of one or more of the set of source packets, as described above.

As further shown in FIG. 8, in some aspects, process 800 may include selecting, from each subset of consecutive packets in the set of rateless code packets, one or more packets with a lowest PAPR among respective PAPRs associated with each packet included in the subset of consecutive packets (block 820). For example, the transmitter (e.g., using communication manager 140 and/or 150 and/or selective mapping component 910, depicted in FIG. 9) may select, from each subset of consecutive packets in the set of rateless code packets, one or more packets with a lowest PAPR among respective PAPRs associated with each packet included in the subset of consecutive packets, as described above.

As further shown in FIG. 8, in some aspects, process 800 may include transmitting a set of output packets that includes the one or more packets selected from each subset of consecutive packets in the set of rateless code packets (block 830). For example, the transmitter (e.g., using communication manager 140 and/or 150 and/or transmission component 904, depicted in FIG. 9) may transmit a set of output packets that includes the one or more packets selected from each subset of consecutive packets in the set of rateless code packets, as described above.

Process 800 may include additional aspects, such as any single aspect or any combination of aspects described below and/or in connection with one or more other processes described elsewhere herein.

In a first aspect, the set of source packets includes k source packets, and the set of rateless code packets includes up to 2^{k} packets that each correspond to a different combination of one or more of the k source packets.

In a second aspect, alone or in combination with the first aspect, each packet in the set of rateless code packets is associated with a rateless code symbol index that defines an XOR relationship with one or more of the set of source packets.

In a third aspect, alone or in combination with one or more of the first and second aspects, a number of packets included in each subset of consecutive packets satisfies a rateless code recovery condition that is based at least in part on a number of packets included in the set of source packets and a number of bits associated with the rateless code symbol index.

In a fourth aspect, alone or in combination with one or more of the first through third aspects, the number of packets included in each subset of consecutive packets is a maximum value that satisfies the rateless code recovery condition.

In a fifth aspect, alone or in combination with one or more of the first through fourth aspects, a percentage of packets in the set of output packets with a degree greater than one is based at least in part on selecting the one or more packets with the lowest PAPR from each subset of consecutive packets.

In a sixth aspect, alone or in combination with one or more of the first through fifth aspects, the set of output packets is associated with a degree distribution that is based at least in part on a number of packets included in each subset of consecutive packets.

In a seventh aspect, alone or in combination with one or more of the first through sixth aspects, selecting the one or more packets with the lowest PAPR from each subset of consecutive packets includes selecting, from each subset of consecutive packets in the set of rateless code packets, a single packet with a lowest PAPR among the respective PAPRs associated with each packet included in the subset of consecutive packets.

In an eighth aspect, alone or in combination with one or more of the first through seventh aspects, selecting the one or more packets with the lowest PAPR from each subset of consecutive packets includes selecting, from each subset of consecutive packets in the set of rateless code packets, a plurality of packets with lowest PAPRs among the respective PAPRs associated with each packet included in the subset of consecutive packets.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a transmitter, or a transmitter may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140 and/or the communication manager 150. The communication manager 140 and/or 150 may include one or more of a rateless encoding component 908 or a selective mapping component 910, among other examples.

In some aspects, the apparatus 900 may be configured to perform one or more operations described herein in connection with FIGS. 7A-7D. Additionally, or alternatively, the apparatus 900 may be configured to perform one or more processes described herein, such as process 800 of FIG. 8. In some aspects, the apparatus 900 and/or one or more components shown in FIG. 9 may include one or more components of the UE and/or the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the transmitter described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the transmitter described in connection with FIG. 2. In some aspects, the transmission component 904 may be co-located with the reception component 902 in a transceiver.

The rateless encoding component 908 may generate, from a set of source packets, a set of rateless code packets that each correspond to a different combination of one or more of the set of source packets. The selective mapping component 910 may select, from each subset of consecutive packets in the set of rateless code packets, one or more packets with a lowest PAPR among respective PAPRs associated with each packet included in the subset of consecutive packets. The transmission component 904 may transmit a set of output packets that includes the one or more packets selected from each subset of consecutive packets in the set of rateless code packets.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a transmitter, comprising: generating, from a set of source packets, a set of rateless code packets that each correspond to a different combination of one or more of the set of source packets; selecting, from each subset of consecutive packets in the set of rateless code packets, one or more packets with a lowest PAPR among respective PAPRs associated with each packet included in the subset of consecutive packets; and transmitting a set of output packets that includes the one or more packets selected from each subset of consecutive packets in the set of rateless code packets.
Aspect 2: The method of Aspect 1, wherein the set of source packets includes k source packets, and wherein the set of rateless code packets includes up to 2^{k} packets that each correspond to a different combination of one or more of the k source packets.
Aspect 3: The method of any of Aspects 1-2, wherein each packet in the set of rateless code packets is associated with a rateless code symbol index that defines an XOR relationship with one or more of the set of source packets.
Aspect 4: The method of Aspect 3, wherein a number of packets included in each subset of consecutive packets satisfies a rateless code recovery condition that is based at least in part on a number of packets included in the set of source packets and a number of bits associated with the rateless code symbol index.
Aspect 5: The method of Aspect 4, wherein the number of packets included in each subset of consecutive packets is a maximum value that satisfies the rateless code recovery condition.
Aspect 6: The method of any of Aspects 1-5, wherein a percentage of packets in the set of output packets with a degree greater than one is based at least in part on selecting the one or more packets with the lowest PAPR from each subset of consecutive packets.
Aspect 7: The method of any of Aspects 1-6, wherein the set of output packets is associated with a degree distribution that is based at least in part on a number of packets included in each subset of consecutive packets.
Aspect 8: The method of any of Aspects 1-7, wherein selecting the one or more packets with the lowest PAPR from each subset of consecutive packets includes selecting, from each subset of consecutive packets in the set of rateless code packets, a single packet with a lowest PAPR among the respective PAPRs associated with each packet included in the subset of consecutive packets.
Aspect 9: The method of any of Aspects 1-7, wherein selecting the one or more packets with the lowest PAPR from each subset of consecutive packets includes selecting, from each subset of consecutive packets in the set of rateless code packets, a plurality of packets with lowest PAPRs among the respective PAPRs associated with each packet included in the subset of consecutive packets.
Aspect 10: An apparatus for wireless communication at a device, comprising a processor; memory coupled with the processor; and instructions stored in the memory and executable by the processor to cause the apparatus to perform the method of one or more of Aspects 1-9.
Aspect 11: A device for wireless communication, comprising a memory and one or more processors coupled to the memory, the one or more processors configured to perform the method of one or more of Aspects 1-9.
Aspect 12: An apparatus for wireless communication, comprising at least one means for performing the method of one or more of Aspects 1-9.
Aspect 13: A non-transitory computer-readable medium storing code for wireless communication, the code comprising instructions executable by a processor to perform the method of one or more of Aspects 1-9.
Aspect 14: A non-transitory computer-readable medium storing a set of instructions for wireless communication, the set of instructions comprising one or more instructions that, when executed by one or more processors of a device, cause the device to perform the method of one or more of Aspects 1-9.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

1. A method of wireless communication performed by a transmitter, comprising:
generating, from a set of source packets, a set of rateless code packets that each correspond to a different combination of one or more of the set of source packets;
selecting, from each subset of consecutive packets in the set of rateless code packets, one or more packets with a lowest peak-to-average power ratio (PAPR) among respective PAPRs associated with each packet included in the subset of consecutive packets; and
transmitting a set of output packets that includes the one or more packets selected from each subset of consecutive packets in the set of rateless code packets.

2. The method of claim 1, wherein the set of source packets includes k source packets, and wherein the set of rateless code packets includes up to 2^{k} packets that each correspond to a different combination of one or more of the k source packets.

3. The method of claim 1, wherein each packet in the set of rateless code packets is associated with a rateless code symbol index that defines an exclusive or (XOR) relationship with one or more of the set of source packets.

4. The method of claim 3, wherein a number of packets included in each subset of consecutive packets satisfies a rateless code recovery condition that is based at least in part on a number of packets included in the set of source packets and a number of bits associated with the rateless code symbol index.

5. The method of claim 4, wherein the number of packets included in each subset of consecutive packets is a maximum value that satisfies the rateless code recovery condition.

6. The method of claim 1, wherein a percentage of packets in the set of output packets with a degree greater than one is based at least in part on selecting the one or more packets with the lowest PAPR from each subset of consecutive packets.

7. The method of claim 1, wherein the set of output packets is associated with a degree distribution that is based at least in part on a number of packets included in each subset of consecutive packets.

8. The method of claim 1, wherein selecting the one or more packets with the lowest PAPR from each subset of consecutive packets includes:
selecting, from each subset of consecutive packets in the set of rateless code packets, a single packet with a lowest PAPR among the respective PAPRs associated with each packet included in the subset of consecutive packets.

9. The method of claim 1, wherein selecting the one or more packets with the lowest PAPR from each subset of consecutive packets includes:
selecting, from each subset of consecutive packets in the set of rateless code packets, a plurality of packets with lowest PAPRs among the respective PAPRs associated with each packet included in the subset of consecutive packets.

10. A transmitter for wireless communication, comprising:
a memory; and
one or more processors, coupled to the memory, configured to:
generate, from a set of source packets, a set of rateless code packets that each correspond to a different combination of one or more of the set of source packets;
select, from each subset of consecutive packets in the set of rateless code packets, one or more packets with a lowest peak-to-average power ratio (PAPR) among respective PAPRs associated with each packet included in the subset of consecutive packets; and
transmit a set of output packets that includes the one or more packets selected from each subset of consecutive packets in the set of rateless code packets.

11. The transmitter of claim 10, wherein the set of source packets includes k source packets, and wherein the set of rateless code packets includes up to 2k packets that each correspond to a different combination of one or more of the k source packets.

12. The transmitter of claim 10, wherein each packet in the set of rateless code packets is associated with a rateless code symbol index that defines an exclusive or (XOR) relationship with one or more of the set of source packets.

13. The transmitter of claim 12, wherein a number of packets included in each subset of consecutive packets satisfies a rateless code recovery condition that is based at least in part on a number of packets included in the set of source packets and a number of bits associated with the rateless code symbol index.

14. The transmitter of claim 13, wherein the number of packets included in each subset of consecutive packets is a maximum value that satisfies the rateless code recovery condition.

15. The transmitter of claim 10, wherein a percentage of packets in the set of output packets with a degree greater than one is based at least in part on selecting the one or more packets with the lowest PAPR from each subset of consecutive packets.

16. The transmitter of claim 10, wherein the set of output packets is associated with a degree distribution that is based at least in part on a number of packets included in each subset of consecutive packets.

17. A non-transitory computer-readable medium storing a set of instructions for wireless communication, the set of instructions comprising:
one or more instructions that, when executed by one or more processors of a transmitter, cause the transmitter to:
generate, from a set of source packets, a set of rateless code packets that each correspond to a different combination of one or more of the set of source packets;
select, from each subset of consecutive packets in the set of rateless code packets, one or more packets with a lowest peak-to-average power ratio (PAPR) among respective PAPRs associated with each packet included in the respective subset of consecutive packets; and
transmit a set of output packets that includes the one or more packets selected from each subset of consecutive packets in the set of rateless code packets.

18. The non-transitory computer-readable medium of claim 17, wherein
the set of source packets includes k source packets, and wherein the set of rateless code packets includes up to 2k packets that each correspond to a different combination of one or more of the k source packets.

19. The non-transitory computer-readable medium of claim 17, wherein
each packet in the set of rateless code packets is associated with a rateless code symbol index that defines an exclusive or (XOR) relationship with one or more of the set of source packets.

20. The non-transitory computer-readable medium of claim 19, wherein a number of packets included in each subset of consecutive packets satisfies a rateless code recovery condition that is based at least in part on a number of packets included in the set of source packets and a number of bits associated with the rateless code symbol index.

21-30. (canceled)
